(19) United States
(12) Patent Application Publication
(10) Pub. No.: US 2019/0193000 A1
(43) Pub. Date: Jun. 27, 2019

(54) GLASS CARTRIDGE FILTERS ESPECIALLY USEFUL AS PART OF WATER-CIRCULATION SYSTEMS OF SWIMMING POOLS OR SPAS

(71) Applicant: Zodiac Group Australia Pty Ltd., Smithfield (AU)

(72) Inventor: Jonathan Bristow, North Parramatta (AU)

(73) Assignee: Zodiac Group Australia Pty Ltd., Smithfield (AU)

(21) Appl. No.: 16/227,831

(22) Filed: Dec. 20, 2018

Related U.S. Application Data
(60) Provisional application No. 62/608,588, filed on Dec. 21, 2017.

(51) Int. Cl. B01D 24/16; B01D 35/30; B01D 39/20; C02F 1/00

(52) U.S. Cl. CPC B01D 24/16; B01D 35/303; B01D 39/2006; C02F 2103/42; B01D 2201/301; B01D 2201/307; B01D 2201/0407; C02F 1/004

(57) ABSTRACT

Modular, stackable filter units are described. The units may contain particles of glass or other filtration material and may be used to cleanse debris-laden water of, for example, swimming pools or spas. They additionally may replace conventional pleated mesh filters and beds of sand if necessary or desired.

### CROSS-REFERENCE TO RELATED APPLICATION

This application claims the benefit of and priority to U.S. Provisional Patent Application Ser. No. 62/608,588, filed Dec. 21, 2017, and having the same title as appears above, the entire contents of which application are hereby incorporated herein by this reference.

### FIELD OF THE INVENTION

This invention relates to fluid-filtration equipment, systems, and methods and more particularly, but not necessarily exclusively, to modular, stackable filter units containing glass.

### BACKGROUND OF THE INVENTION

Many water-circulation systems for swimming pools and spas include at least one filter. Under influence of a pump, water may be evacuated from a vessel such as a pool or spa, passed through the filter, and thereafter returned to the vessel. Because the evacuated water typically is laden with debris (e.g. dirt, leaves, sticks, bacteria), passing it through a filter allows capture of some or most of the debris, resulting in cleaner water being returned to the pool or spa.

A common filter for these circulation systems contains a (relatively dense) bed of sand particles. As debris-laden water passes through the sand bed, some debris is captured in the bed, thereby eliminating it from the water stream. Periodically the bed must be backwashed to remove the built-up debris. Sand also is prone to clumping and calcifying and, when clumped, may create channels between sand grains allowing water to flow unfiltered.

Consequently, filters containing solid mesh material also are used with pools and spas. Cartridges containing pleated mesh, for example, are common in the industry. When soiled, the cartridges may be withdrawn from their containers and washed with water to remove captured dirt and debris, following which they may be returned to their containers.

Pool and spa water additionally may be treated chemically to enhance its cleanliness. Conventionally chlorine is employed as the primary sanitizing chemical. Silver ion-based technologies also exist. The MagnaPool system of the Zodiac Pools group of companies (“Zodiac”) provides yet another, magnesium-based, type of chemical treatment for pool and spa water. Coagulating effects of magnesium tend to clog standard pleated cartridges, however, sometimes requiring them to be discarded rather than re-used.

Zodiac thus recommends using glass filtration—rather than employing (only) sand or pleated mesh filters, for example—in connection with its MagnaPool system. Beds of glass particles are less dense than similar beds of sand and thus admit more efficient cleaning. Rather than capturing dirt and debris solely mechanically, the glass does so in part electrostatically (in the applicant's understanding). Glass further resists breakdown better than sand particles when backwashed, minimizing cracks in which bacteria can lodge.

### SUMMARY OF THE INVENTION

The present invention seeks to provide containers for glass filtration media. The containers advantageously are modular and stackable, allowing their use as replacements in certain existing cartridge filters, for example. The containers further may be backwashed using simply a garden or similar hose, consistent with governmental regulations in certain areas.

### BRIEF DESCRIPTION OF THE DRAWINGS

FIGS. 1A-B are perspective views of an exemplary container consistent with the present invention.

FIG. 2 is an exploded perspective view of the container of FIGS. 1A-B.

FIG. 3 is a perspective, partially cross-sectioned view of stackable containers of FIGS. 1A-B.

FIGS. 4A-B are perspective views of sets of stacked containers of FIGS. 1A-B.

FIG. 5 is a perspective, partially cross-sectioned view of the stack of containers of FIG. 4A within a cartridge filter tank.

### DETAILED DESCRIPTION

FIGS. 1A-5 illustrate exemplary container 10 of the present invention. Container 10 beneficially may include basket 14 and lid 18. Lid 18 may be secured to basket 14 (as by interlocking threads, for example) in use, hence defining a structure suitable for containing material and, if desirable, removable from basket 14 to remove or replace the contained material. Preferably confined within container 10 is media such as glass particles available for use for purposes of filtering water of swimming pools or spas.

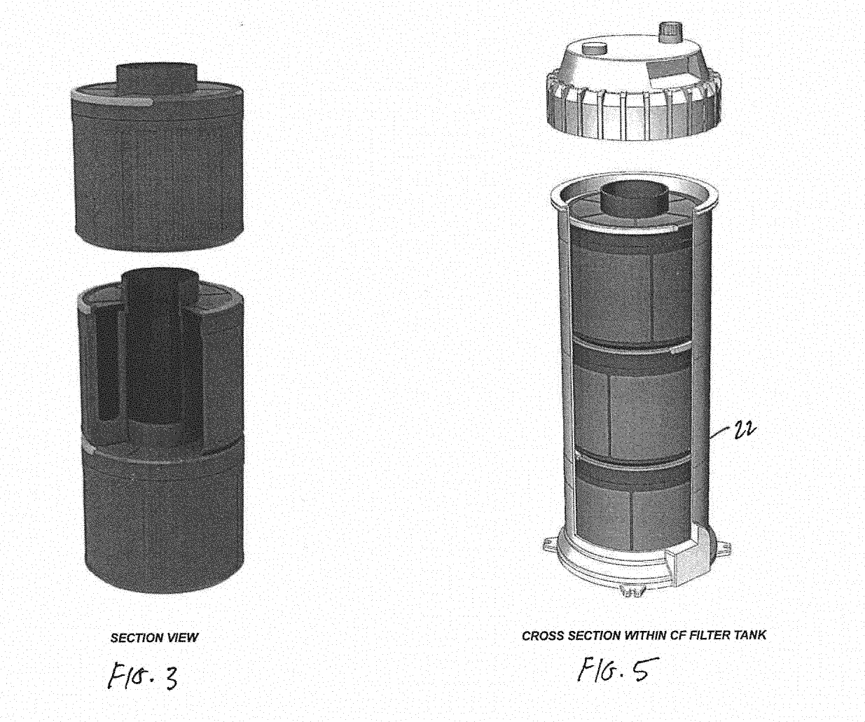

As shown, both basket 14 and lid 18 have circular cross-sections. Although this configuration is advantageous for placement of container 10 within, for example, cartridge filter tank 22 (see FIG. 5), it is not necessary. Indeed, each of basket 14 and lid 18 may have any suitable shape. Both basket 14 and lid 18 also are shown as having perforated walls: Outer side wall 26 and nominally lower wall 30 of basket 14 may be perforated, as may be nominally upper wall 34 of lid 18. The perforations allow water to pass into and out of container 10, reducing the head loss that passage of water through container 10 otherwise would create.

Basket 14 and lid 18 preferably are made of “rigid” plastic or other suitable material. In this sense, “rigid” means that, when combined into container 10, these components are capable of supporting a designated weight without collapsing or otherwise deforming materially. In some versions of the invention, the designated weight may range between 5-30 kilograms, although lower or higher values may be designated as needed.

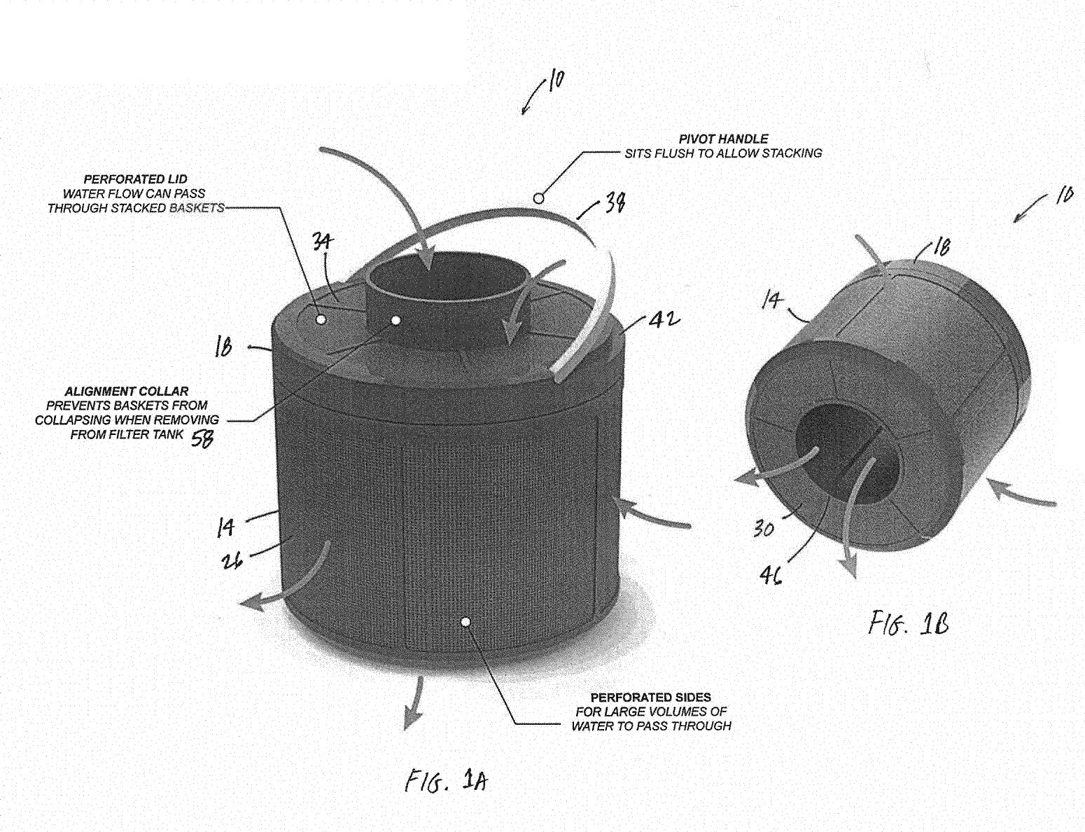

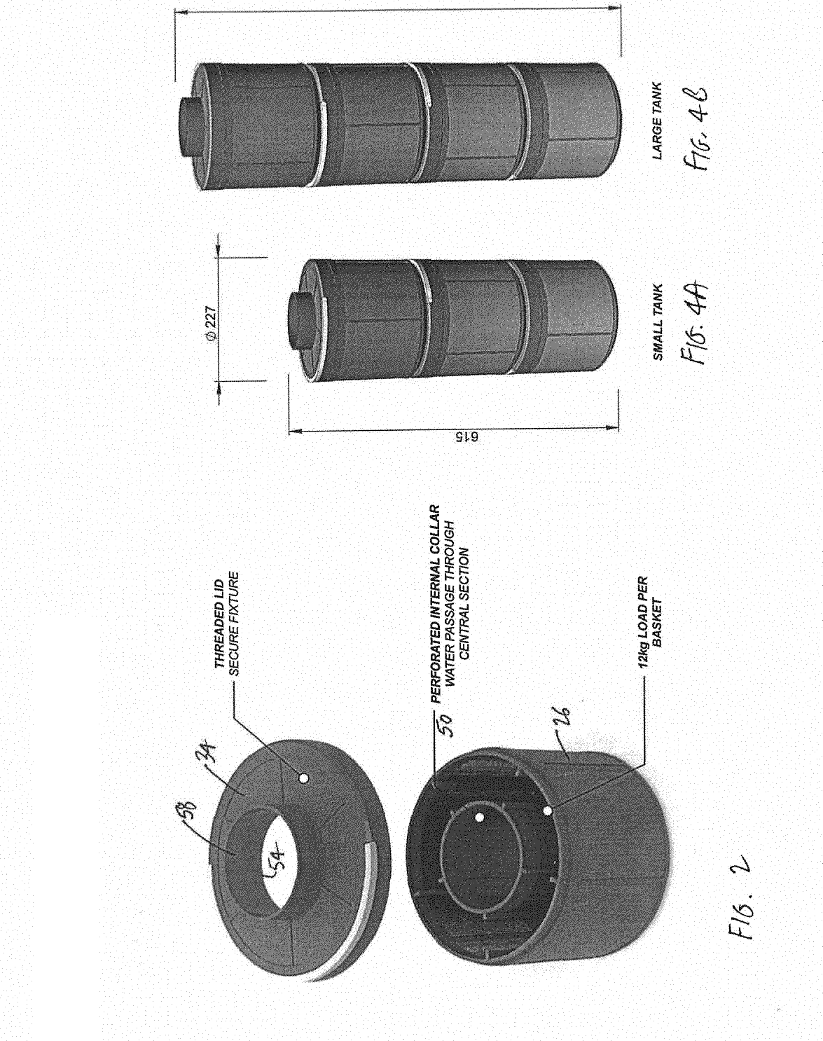

Accordingly, containers 10 may be stacked, one atop another, as illustrated in FIGS. 3, 4A-B, and 5. FIG. 5 details three such stacked containers 10 fitted within tank 22, allowing the containers 10 to substitute for the pleated mesh or other filters previously present in tank 22. Of course, tank 22 or another tank could be made so as to be dedicated to receive one or more containers 10.

To facilitate stacking and unstacking of containers 10, lid 18 may be outfitted with handle 38. In the version of container 10 shown in FIG. 1A, for example, upper wall 34 may have reduced size along a portion of its periphery so as to form semi-circular recess 42. Handle 38 additionally may be semi-circular, allowing it to fit within recess 42 flush with wall 34 when not in use. By contrast, for use, handle 38 may be removed from recess 42 to a position similar to that illustrated in FIG. 1A, allowing it to be grasped easily by a person.

Whereas outer side wall 26 beneficially forms a cylinder, each of lower wall 30 and upper wall 34 is generally annular in shape. Extending nominally upward from internal periphery 46 of lower wall 30 of basket 14 may be internal collar 50, which itself may be perforated. Likewise, extending nominally upward from internal periphery 54 of upper wall 34 may be alignment collar 58. Unlike internal collar 50, alignment collar 58 preferably is unperforated.

When lid 18 is secured to basket 14 for use, collars 50 and 58 are aligned (nominally vertically) so as to form an unfettered central passage in which water may flow. Moreover, when two containers 10 are stacked, alignment collar 58 of the “lower” container 10 may be received within internal collar 50 of the “upper” container 10, establishing the modular, nestable nature of the devices. The solid nature of collar 58 (effectively making it a flange) also may help prevent collapse of the container 10 when handle 38 is grasped and pulled.

Arrows in FIG. 1A-B identify some ways in which water may flow into, out of, and through container 10. Water entering container 10 (other than merely passing through the unfettered central passage) contacts the glass particles or other filtration media contained therein, thereby cleansing the water of at least some particulates before the water exits container 10 for eventual return to the pool or spa.

The present invention hence defines a manner in which glass media may be used for filtration. Modular containers such as baskets may be partially or completely filled with particles of glass or other filtration material, and one or more containers may then be inserted into a cartridge filter. This allows for the glass filtration to occur within the small footprint of the cartridge filter. It also facilitates cleaning of the containers, which may be easily lifted out of cartridge filters and washed with standard hoses.

Preferably, perforations of a container are less than one millimeter (1 mm) in size, so that particles of at least this size may be successfully contained with the container. A particular perforation size is not critical to the invention, however, as filtration particles of smaller or larger size may be selected instead. Containers advantageously may be strong enough to support the maximum number of fully-loaded containers intended to be stacked upon the bottom-most container. The containers also beneficially are uniformly sized and shaped to facilitate efficient stacking.

The foregoing is provided for purposes of illustrating, explaining, and describing embodiments of the present invention. Modifications and adaptations to these embodiments will be apparent to those skilled in the art and may be made without departing from the scope or spirit of the invention. Filter elements such as those disclosed in International Patent Application Publication No. WO 2016/185159 (the “'159 PCT Application”) may be utilized in connection with the present invention if desired, and the entire contents of the '159 PCT Application are incorporated herein by this reference.

What is claimed is:

1. A fluid-filtration container comprising:
a. a basket comprising (i) a perforated, generally cylindrical outer side wall, (ii) a perforated, generally annular nominally lower wall defining an internal periphery, and (iii) an internal collar extending from the internal periphery of the nominally lower wall; and
b. a lid configured to be secured to the basket in use and comprising (i) a perforated nominally upper wall defining an internal periphery and (ii) an alignment collar extending from the internal periphery of the nominally upper wall.

2. A fluid-filtration container according to claim 1 in which, when the lid is secured to the basket in use, the internal collar and the alignment collar are aligned so as to form a central passage in which water may flow.

3. A fluid-filtration container according to claim 1 further comprising glass particles.

4. A fluid-filtration container according to claim 2 further comprising glass particles.

5. A fluid-filtration container according to claim 4 in which the nominally upper wall of the lid defines a recess, further comprising a handle configured, when not in use, to fit within the recess flush with the nominally upper wall.

6. A fluid-filtration container according to claim 5 in which the basket and the lid are made of rigid material.

7. A tank of a water-circulation system of a swimming pool or spa, comprising:
a. an interior; and
b. a plurality of containers stacked within the interior, each container containing particulate filtration material other than sand and comprising at least one perforated wall.

8. A tank according to claim 7 in which the particulate filtration material comprises glass.

9. A tank according to claim 8 in which each container comprises a basket and a lid, at least one of the basket or lid having the at least one perforated wall.

10. A tank according to claim 9 in which the at least one perforated wall comprises first and second perforated walls, the first perforated wall forming an outer side wall of the basket and the second perforated wall forming a nominally upper wall of the lid.

11. A tank according to claim 10 in which the at least on perforated wall further comprises a third perforated wall forming a nominally lower wall of the basket.

12. A tank according to claim 11 in which each of the nominally lower wall and the nominally upper wall defines an internal periphery, further comprising (a) an internal collar extending from the internal periphery of the nominally lower wall and (b) an alignment collar extending from the internal periphery of the nominally upper wall.

13. A tank according to claim 12 in which (a) the plurality of containers comprises first and second containers and (b) the alignment collar of the first container is received within the internal collar of the second container.
